(19) United States
(12) Patent Application Publication
(10) Pub. No.: US 2016/0254569 A1
(43) Pub. Date: Sep. 1, 2016

(54) ASSEMBLED BATTERY

(71) Applicant: HITACHI AUTOMOTIVE SYSTEMS, LTD., Hitachinaka-shi (JP)

(72) Inventors: Yohshin YAGI, Hitachinaka (JP); Naoki YAMADA, Hitachinaka (JP)

(73) Assignee: HITACHI AUTOMOTIVE SYSTEMS, LTD., Hitachinaka-shi (JP)

(21) Appl. No.: 15/029,751

(22) PCT Filed: Nov. 19, 2013
(86) PCT No.: PCT/JP2013/081093

§ 371 Date: Apr. 15, 2016

(51) Int. Cl. H01M 10/0587; H01M 10/02; H01M 10/04; H01M 2/10; H01M 4/13; H01M 4/139

(52) U.S. Cl. CPC H01M 10/0587; H01M 4/13; H01M 4/139; H01M 10/0431; H01M 10/0481; H01M 2/1077; H01M 10/02; H01M 2004/025

(57) ABSTRACT

An assembled battery is formed by laminating secondary batteries each including a flat wound electrode group formed by winding a laminated body including positive and negative electrodes laminated with separators interposed therebetween and a flat battery container for housing the wound electrode group with a spacer interposed therebetween. The wound electrode group has a flat portion where the laminated body is formed by flat lamination and a curved portion where the laminated body is formed by curved lamination. The spacer has an abutting portion that abuts on a wide surface of the battery container within a range facing the inner side of the both ends of the flat portion and a facing portion that faces the wide surface of the battery container within a range facing the curved portion. The thickness of the facing portion is smaller than the thickness of the abutting portion.

### TECHNICAL FIELD

The present invention relates to an assembled battery, particularly to an assembled battery formed by laminating a plurality of flat secondary batteries with a spacer interposed therebetween.

### BACKGROUND ART

In the field of a rechargeable secondary battery, an aqueous solution type battery such as a lead battery, a nickel-cadmium battery, or a nickel-hydrogen battery has been mainly used conventionally. However, as miniaturization and weight reduction of electric devices proceed, a lithium ion secondary battery having a high energy density has been focused, and research, development, and commercialization thereof have been advanced rapidly. An electric vehicle (EV) and a hybrid electric vehicle (HEV) to assist a part of driving by an electric motor have been developed by car manufacturers in view of a problem such as global warming or fuel depletion. A secondary battery having a high capacity and a high output has been demanded as a power source therefor.

As a power source that meets these requirements, a non-aqueous solution type lithium ion secondary battery having a high voltage is attracting attention. Particularly, a prismatic lithium ion secondary battery containing a flat box-type battery container has an excellent volumetric efficiency when being packed. Therefore, expectation for development thereof is increasing as a power source for an HEV or an EV.

However, in the prismatic lithium ion secondary battery, a material of an electrode housed in the battery container is expanded or shrunk with charging and discharging, and therefore expansion of the battery container cannot be avoided. As a method for suppressing such expansion of the battery container caused by expansion of the electrode in charging and discharging of the secondary battery, a method for tightening a battery container from the outside is known (for example, refer to PTL 1 below).

A lithium ion assembled battery for a vehicle described in PTL 1 includes a laminated body formed by alternately laminating four lithium ion batteries and five metal heat radiation plates having surfaces subjected to an insulating treatment. Each lithium ion battery has a metallic flat-box type housing. Each metal heat radiation plate having a surface subjected to an insulating treatment is disposed in contact with both side faces of each lithium ion battery. A pair of end plates and tightening belts mounted on the end plates are disposed in a periphery of the laminated body. The end plates and the tightening belts are mutually tightened.

### CITATION LIST

### Patent Literature

PTL 1: Japanese Patent Application Laid-Open 2004-227788

### SUMMARY OF INVENTION

### Technical Problem

The assembled battery described in PTL 1 includes a battery laminated roll body housed in the housing. The battery laminated roll body is formed by superimposing two electrodes having an active material applied with a separator interposed therebetween and winding this product into a roll shape. Such a battery laminated roll body having no axial core is wound, for example, into an oval shape in winding, then is pressed between a pair of flat surfaces parallel to each other, and is formed into a flat shape.

In the battery laminated roll body formed into a flat shape, a pair of curved portions faces a bottom surface and a lid of the housing, and a flat portion between the pair of curved portions faces a wide side surface having the largest area in the housing. In the assembled battery of PTL 1, tightening the laminated body formed of the batteries and the metal heat radiation plates with the end plates and the tightening belts while the metal heat radiation plates are in contact with this wide side surface suppresses deformation of the housing of the battery.

However, the metal heat radiation plates described in PTL 1 face the entire battery laminated roll body, that is, the entire roll body including the flat portion of the roll body and the curved portions on both sides thereof. Therefore, when the roll body is brought into contact with the housing by expansion and receives a tightening force from the metal heat radiation plate in contact with the housing, the roll body is in a state similar to the state in which the roll body is pressed flatly between the pair of flat surfaces.

That is, as described above, the battery laminated roll body having no axial core causes a peripheral length difference between the electrodes superimposed with a separator interposed therebetween in winding. Therefore, pressing the entire battery laminated roll body between the pair of flat surfaces and molding the entire battery laminated roll body into a flat shape increases a distance between the electrodes due to the peripheral length difference between the electrodes and generates a gap between the electrodes in the curved portions on both sides of the flat portion. This gap is larger as the distance to the apex of the curved portion is shorter. Charging and discharging a lithium ion battery in such a state increases resistance between positive and negative electrodes in a portion having a large gap between the electrodes, and causes deposition of metal lithium easily on the negative electrode. In the portion having metal lithium deposited on the electrode, charging and discharging performance of the electrode is deteriorated.

The present invention has been achieved in view of the above problems. An object thereof is to provide an assembled battery capable of suppressing expansion of a battery container of a secondary battery, suppressing local deposition of metal lithium onto an electrode in a wound electrode group, and suppressing deterioration of charging and discharging performance of the secondary battery.

### Solution to Problem

In order to achieve the above object, an assembled battery of the present invention is characterized by the following. That is, the assembled battery of the present invention is formed by laminating secondary batteries each including a flat wound electrode group formed by winding a laminated body including positive and negative electrodes laminated with a separator interposed therebetween and a flat battery container for housing the wound electrode group with a spacer interposed therebetween. The wound electrode group has a flat portion where the laminated body is formed by flat lamination and a curved portion where the laminated body is formed by curved lamination at least in a part at both ends of the flat portion. The spacer has an abutting portion that abuts on a wide surface of the battery container within a range facing the inner side of the both ends of the flat portion and a facing portion that faces the wide surface of the battery container within a range facing the curved portion. The thickness of the facing portion is smaller than the thickness of the abutting portion.

### Advantageous Effects of Invention

The assembled battery of the present invention can suppress expansion of the battery container by tightening the wide surface of the battery container with the abutting portion that abuts on the wide surface of the battery container within a range facing the inner side of the both ends of the flat portion during expansion of the battery container caused by expansion of the wound electrode group in the secondary battery. The abutting portion does not abut on the wide surface of the battery container within a range facing the curved portion in the wound electrode group, and the thickness of the facing portion is smaller than that of the abutting portion. Therefore, expansion of the battery container is allowed within the range, and the distance between the electrodes is made uniform in the curved portion. This can provide an assembled battery suppressing local deposition of metal lithium onto the electrode and suppressing deterioration of charging and discharging performance of the secondary battery.

Problems, structures, and effects other than the above will be clarified by the following description of embodiments.

### BRIEF DESCRIPTION OF DRAWINGS

FIG. 1A is a perspective view of an assembled battery according to a first embodiment of the present invention.

FIG. 1B is a side view of the assembled battery illustrated in FIG. 1A.

FIG. 2 is a disassembled perspective view of a secondary battery included in the assembled battery illustrated in FIGS. 1A and 1B.

FIG. 3 is a disassembled perspective view of a wound electrode group included in the secondary battery illustrated in FIG. 2.

FIG. 4A is a schematic cross sectional view for describing a part of a process for manufacturing the wound electrode group illustrated in FIG. 3.

FIG. 4B is a schematic cross sectional view for describing a part of the process for manufacturing the wound electrode group illustrated in FIG. 3.

FIG. 5A is a cross sectional view cut along Va-Va line in FIG. 1A.

FIG. 5B is an enlarged cross sectional view of a curved portion in a state where the wound electrode group illustrated in FIG. 4B is pressed.

FIG. 6A is a cross sectional view illustrating a state where a battery container in the secondary battery illustrated in FIG. 5A is expanded.

FIG. 6B is an enlarged cross sectional view illustrating the curved portion in the wound electrode group illustrated in FIG. 6A.

FIG. 7A is a perspective view illustrating a modified example of the assembled battery illustrated in FIG. 1A.

FIG. 7B is a side view of the assembled battery illustrated in FIG. 7A.

FIG. 8 is a side cross sectional view of an assembled battery according to a second embodiment, corresponding to FIG. 1B.

### DESCRIPTION OF EMBODIMENTS

Hereinafter, embodiments of the assembled battery of the present invention will be described in detail with reference to the drawings.

### First Embodiment

### Assembled Battery

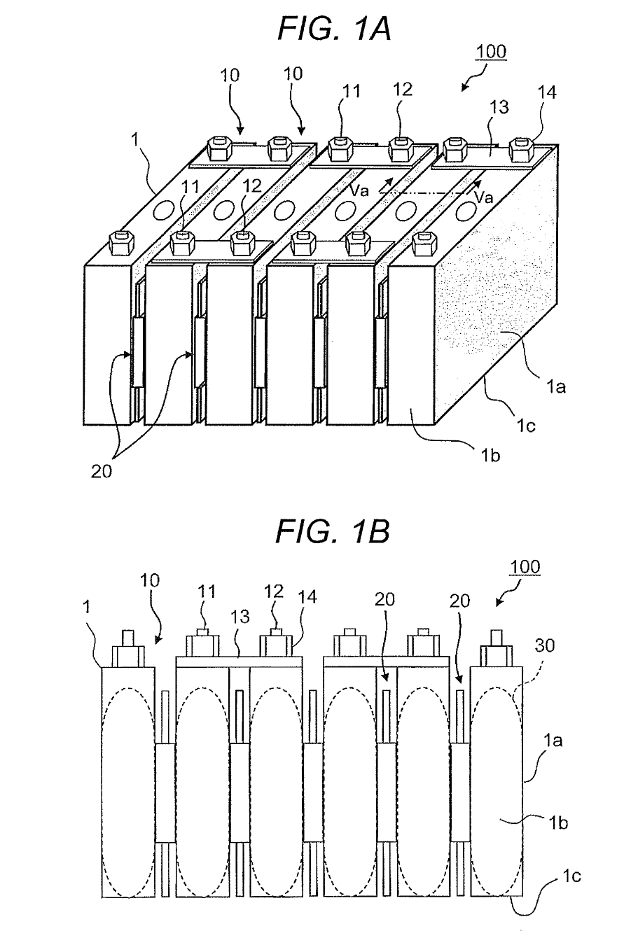

FIG. 1A is a perspective view of an assembled battery according to a first embodiment of the present invention. FIG. 1B is a side view of the assembled battery illustrated in FIG. 1A.

As illustrated in FIGS. 1A and 1B, an assembled battery 100 has a structure formed by laminating a plurality of secondary batteries 10 with a spacer 20 interposed therebetween. In the present embodiment, a prismatic lithium ion secondary battery including a flat rectangular box-shaped battery container 1 having a rectangular parallelepiped shape is used as the secondary battery 10. The battery container 1 in the secondary battery 10 has a wide surface 1a that is a side surface having a large area, a narrow surface 1b that is a side surface having a small area, and a bottom surface 1c.

The plurality of secondary batteries 10 is laminated such that the wide surfaces 1a of the battery containers 1 face each other, and are adjacent to each other at a predetermined interval with the spacer 20 interposed between the wide surfaces 1a. The spacer 20 is extended in a width direction of the wide surface 1a of the battery container 1, that is, over approximately the entire width of the wide surface 1a in a direction perpendicular to the narrow surface 1b. On both sides of the plurality of secondary batteries 10 laminated with the spacer 20 interposed therebetween, a pair of metal plates is disposed such that each of the metal plates faces one of the wide surfaces 1a of the battery container 1 in each secondary battery 10 on each side (not illustrated). Fastening the pair of metal plates mutually with a bolt or the like tightens the plurality of secondary batteries 10 laminated, and suppresses expansion of the battery container 1 in each secondary battery 10. Examples of a material of the metal plate include stainless steel and copper.

In the assembled battery 100 of the present embodiment, the plurality of secondary batteries 10 is laminated alternately such that a positive electrode external terminal 11 is positioned so as to be opposite to a negative electrode external terminal 12 by 180° between the adjacent secondary batteries 100. The plurality of secondary batteries 10 is connected electrically in series by connection of the positive electrode external terminal 11 and the negative electrode external terminal 12 in the adjacent secondary batteries 10 with a bus bar 13. The bus bar 13 has, for example, a through hole for inserting a bolt of each of the positive electrode external terminal 11 and the negative electrode external terminal 12 thereinto, and is connected to the positive electrode external terminal 11 and the negative electrode external terminal 12 by inserting the bolt of each of the positive electrode external terminal 11 and the negative electrode external terminal 12 into the through hole and fastening the bolt with a nut 14.

### (Secondary Battery)

Next, the structure of the secondary battery 10 included in the assembled battery 100 of the present embodiment will be described.

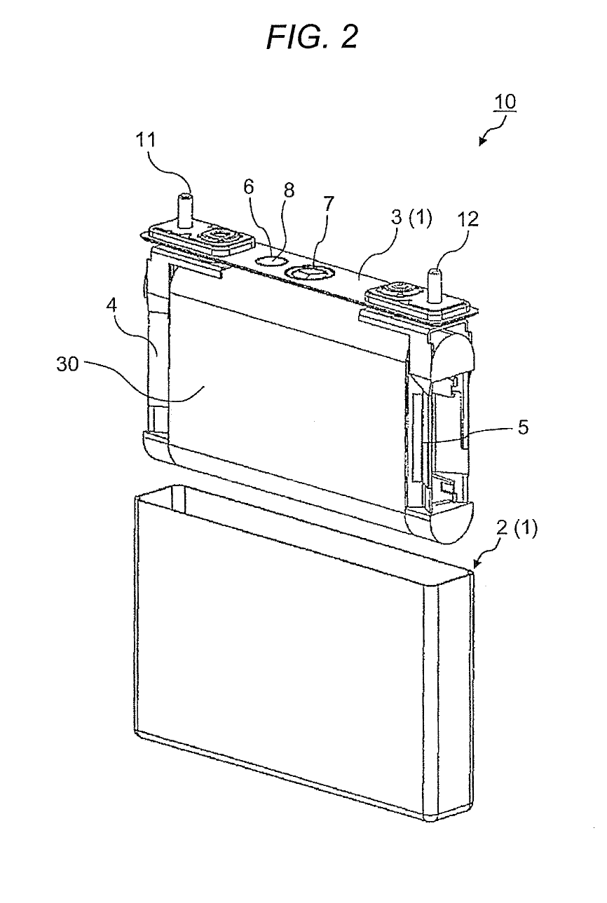

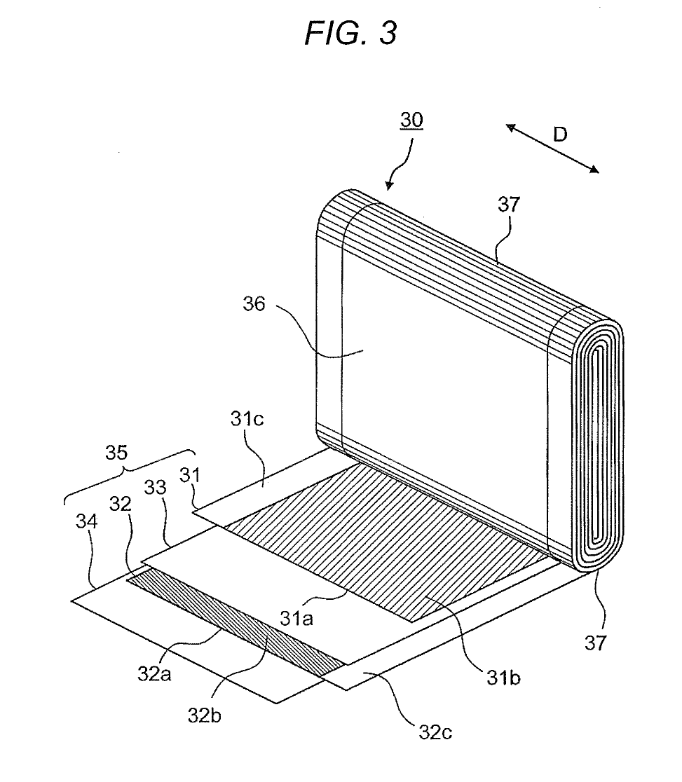

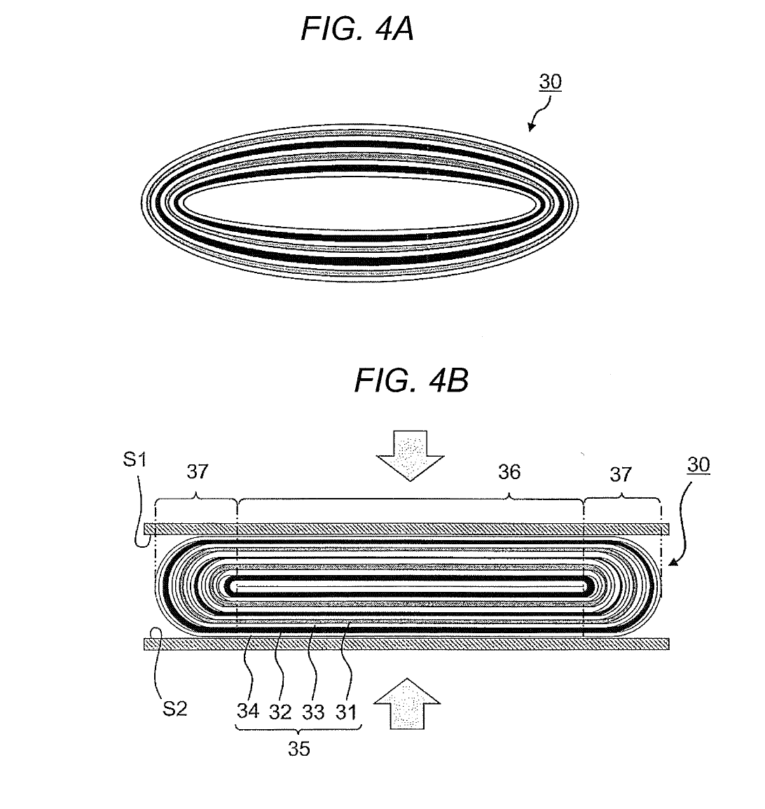

FIG. 2 is a disassembled perspective view of the secondary battery 10 included in the assembled battery 100 illustrated in FIGS. 1A and 1B. FIG. 3 is a disassembled perspective view of a wound electrode group 30 included in the secondary battery illustrated in FIG. 2. FIGS. 4A and 4B are schematic cross sectional views for describing a part of a process for manufacturing the wound electrode group 30 illustrated in FIG. 3.

The secondary battery 10 includes the prismatic flat battery container 1. The battery container 1 includes a rectangular box-shaped battery can 2 having an opening and a battery lid 3 for sealing the opening of the battery can 2. The battery can 2 and the battery lid 3 are formed, for example, of aluminum or an aluminum alloy, and the battery container 1 is sealed by bonding the battery lid 3 to the entire periphery of the opening of the battery can 2, for example, by laser welding. The wound electrode group 30 is housed in the battery container 1.

As illustrated in FIG. 3, the wound electrode group 30 is formed by winding a laminated body 35 including a positive electrode 31 and a negative electrode 32 laminated with separators 33 and 34 interposed therebetween. The wound electrode group 30 is wound while, for example, a tensile load of about 10 N is applied in a direction in which the strip-shaped laminated body 35 is extended. At this time, the wound electrode group 30 is wound while meandering control is performed such that ends of the positive electrode 31, the negative electrode 32, and the separators 33 and 34 at both ends in a winding axis direction D are at fixed positions.

In this way, as illustrated in FIG. 4A, the wound electrode group 30 is wound into an oval shape in a cross sectional view perpendicular to the winding axis direction D. As illustrated in FIG. 4B, the wound electrode group 30 wound into an oval shape is pressed and compressed between a pair of flat surfaces S1 and S2 parallel to each other. The wound electrode group 30 is thereby formed into a flat shape having a flat and a curved portion 37. In the flat portion 36, the laminated body 35 is formed by flat lamination from the innermost periphery to the outermost periphery. In the curved portion 37, the laminated body 35 is formed by curved lamination at least in a part at both ends of the flat portion 36.

The positive electrode 31 has a positive electrode mixture 31b formed on each side of a positive electrode foil 31a and an exposed portion 31c in which the positive electrode foil 31a is exposed on one end side in the winding axis direction D of the wound electrode group 30. The negative electrode 32 has a negative electrode mixture layer 32b formed on each side of a negative electrode foil 32a and a foil-exposed portion 32c in which the negative electrode foil 32a is exposed on the other end side in the winding axis direction D of the wound electrode group 30. The foil-exposed portions 31c and 32c in the positive electrode 31 and the negative electrode 32 are wound so as to be at opposite positions to each other in the winding axis direction D.

Each of the separators 33 and 34 is formed, for example, of a polyethylene insulating material having a micropore, and insulates the positive electrode 31 and the negative electrode 32. The negative electrode mixture layer 32b in the negative electrode 32 is larger in a width direction than the positive electrode mixture layer 31b in the positive electrode 31. The positive electrode mixture layer 31b is thereby formed so as to be necessarily sandwiched by the negative electrode mixture layers 32b.

The foil-exposed portions 31c and 32c of the wound electrode group 30 are bundled by the flat portion 37. As illustrated in FIG. 2, the foil-exposed portions 31c and 32c are bonded to a positive electrode current collector plate 4 and a negative electrode current collector plate 5, respectively, for example, by ultrasonic welding, and are electrically connected to the positive electrode current collector plate 4 and the negative electrode current collector plate 5, respectively. Examples of a material of the positive electrode current collector plate 4 include aluminum and an aluminum alloy. Examples of a material of the negative electrode current collector plate 5 include copper and a copper alloy.

The positive electrode current collector plate 4 and the negative electrode current collector plate 5 are electrically connected to the positive electrode external terminal 11 and the negative electrode external terminal 12 with connecting terminals passing through the battery lid 3, respectively. The positive electrode current collector plate 4, the positive electrode external terminal 11, the negative electrode current collector plate 5, and the negative electrode external terminal 12 are fixed while being electrically insulated with respect to the battery lid 3. The battery lid 3 includes an injection hole 6 for injecting an electrolytic solution and a gas discharge valve 7 that is opened when the pressure in the battery container 1 increases above a predetermined value. The injection hole 6 is sealed by bonding of an injection plug 8, for example, by laser welding after a nonaqueous electrolytic solution is injected into the battery container 1.

Examples of the nonaqueous electrolytic solution injected into the battery container 1 include a solution obtained by dissolving at a concentration of 1 mol/liter lithium hexafluorophosphate (LiPF₆) in a mixed solution of ethylene carbonate and dimethyl carbonate at a volume ratio of 1:2. The nonaqueous electrolytic solution is not limited to a lithium salt or an organic solvent. A general lithium salt may be used as an electrolyte, and a nonaqueous electrolytic solution obtained by dissolving the general lithium salt in an organic solvent may be used. Examples of the electrolyte include LiClO₄, LiAsF₆, LiBF₄, LiB(C₆H₅)₄, CH₃SO₃Li, CF₃SO₃Li, and a mixture thereof. Examples of the organic solvent include propylene carbonate, ethylene carbonate, 1,2-dimethoxyethane, 1,2-diethoxyethane, γ-butyrolactone, tetrahydrofuran, 1,3-dioxolane, 4-methyl-1,3-dioxolane, diethyl ether, sulfolane, methyl sulfolane, acetonitrile, propionitrile, and a mixed solvent of two or more kinds thereof. A mixing proportion is not particularly limited.

For example, the positive electrode 31 can be manufactured by the following procedures. First, lithium-containing multiple oxide powder as a positive electrode active material, scaly graphite as a conductive material, and polyvinylidene fluoride (PVDF) as a binder are mixed at a weight ratio of 85:10:5. Subsequently, slurry obtained by adding N-methylpyrrolidone (NMP) as a dispersion solvent to this mixture and kneading the resulting mixture is applied onto both surfaces of an aluminum foil having a thickness of 20 μm as the positive electrode foil 31a, and is dried. Thereafter, this product is pressed and cut, and the positive electrode 31 having the positive electrode mixture layer 31b on the surface of the positive electrode foil 31a is thereby obtained. One end of the positive electrode foil 31a in a width direction is the foil-exposed portion 31c without the positive electrode mixture layer 31b, and is used as a positive electrode lead.

For example, the positive electrode 32 can be manufactured by the following procedures. First, amorphous carbon powder as a negative electrode active material and PVDF as a binder are mixed. Slurry obtained by NMP as a dispersion solvent to this mixture and kneading the resulting mixture is applied onto both surfaces of a rolled copper foil having a thickness of 10 μm as the negative electrode foil 32a, and is dried. Thereafter, this product is pressed and cut, and the negative electrode 32 having the negative electrode mixture layer 32b on the surface of the negative electrode foil 32a is thereby obtained. One end of the negative electrode foil 32a in a width direction is the foil-exposed portion 32c without the negative electrode mixture layer 32b, and is used as a negative electrode lead.

In the present embodiment, amorphous carbon has been exemplified as the negative electrode active material. However, the negative electrode active material is not particularly limited, and examples thereof include a carbonaceous material such as natural graphite capable of inserting and removing a lithium ion, various types of artificial graphite materials, or coke. The particle shape of the negative electrode active material is not particularly limited. Examples thereof include a flaky shape, a spherical shape, a fibrous shape, and a bulk shape. In the present embodiment, PVDF has been exemplified as the binder. However, examples of the binder include a polymer such as polytetrafluoroethylene (PTFE), polyethylene, polystyrene, polybutadiene, butyl rubber, nitrile rubber, styrene/butadiene rubber, polysulfide rubber, cellulose nitrate, cyanoethyl cellulose, latex, acrylonitrile, vinyl fluoride, vinylidene fluoride, propylene fluoride, or chloroprene fluoride, and a mixture thereof.

### (Spacer)

Next, the spacer 20 included in the assembled battery 100 of the present embodiment will be described.

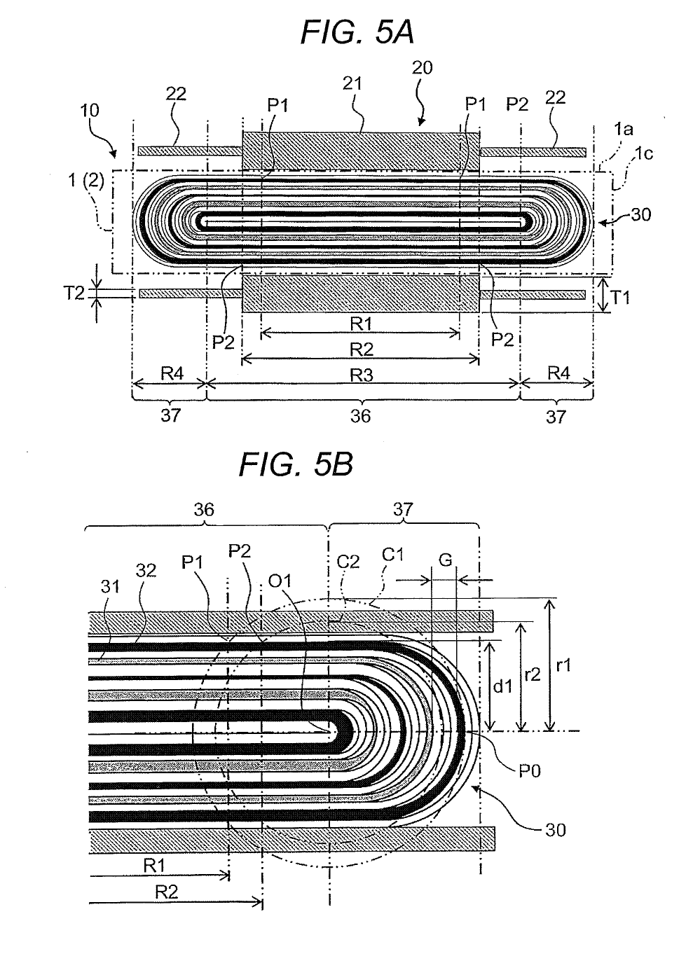

FIG. 5A is a cross sectional view of the assembled battery 100, cut along Va-Va line in FIG. 1A. FIG. 5B is an enlarged cross sectional view of the curved portion 37 in a state where the wound electrode group 30 illustrated in FIG. 4B is pressed. In FIG. 5A, the battery container 1 is not illustrated, and the external shape of the battery can 2 is illustrated by a virtual line.

As illustrated in FIG. 5A, the spacer 20 has an abutting portion 21 that abuts on the wide surface 1a of the battery container 1 and a facing portion 22 that faces the wide surface 1a of the battery container 1. A thickness T2 of the facing portion 22 is smaller than a thickness T1 of the abutting portion. Examples of a material of the spacer 20 include a resin material such as a glass epoxy resin, polypropylene, or a PBT resin, and a metal material such as aluminum, copper, or stainless steel. The spacer 20 can be integrated with a container for housing the assembled battery 100 or a battery holder for holding each secondary battery 10.

The abutting portion 21 abuts on the wide surface 1a of the battery container 1 within a range R3 facing the inner side of both ends of the flat portion 36 in the wound electrode group 30, but is not disposed within a range R4 facing the curved portion 37. The facing portion 22 faces the wide surface 1a of the battery container 1 within the range R4 facing the curved portion 37 in the wound electrode group 30. The facing portion 22 preferably faces the entire curved portion 37 in a height direction of the battery container 1, that is, in a direction perpendicular to the bottom surface 1c, but may face a part of the curved portion 37.

In the present embodiment, as illustrated in FIG. 4B, the flat portion 36 of the wound electrode group 30 is a portion where the laminated body 35 is formed by flat lamination, that is, the positive electrode 31, the negative electrode 32, and the separators 33 and 34 are laminated flatly from the innermost periphery to the outermost periphery. That is, the flat portion 36 is a portion where the entire laminated body 35, that is, all of the positive electrode 31, the negative electrode 32, and the separators 33 and 34 are flat from the innermost periphery to the outermost periphery when the wound electrode group 30 is pressed and compressed flatly between the pair of flat surfaces S1 and S1 parallel to each other. Here, “being flat” means “having a planar shape along the wide surface 1a of the battery container 1” as illustrated in FIG. 5A.

In the present embodiment, the curved portion 37 of the wound electrode group 30 is a portion positioned at both ends of the flat portion 36 in a height direction of the battery container 1, that is, in a direction perpendicular to the bottom surface 1c, where the laminated body 35 is formed by curved lamination at least in a part, that is, the positive electrode 31, the negative electrode 32, and the separators 33 and 34 are laminated curvedly at least in a part. In the curved portion 37, a member of the laminated body 35 other than the separator 33 or the negative electrode 32 wound in the innermost periphery has not only a portion curved in an arc shape but also a flat portion near the boundary between the curved portion 37 and the flat portion 36. In the flat portion included in the curved portion 37 of the laminated body 35, the size of the outer periphery is larger than that of the inner periphery in a height direction perpendicular to the bottom surface 1c of the battery container 1 due to the peripheral length difference in the members of the laminated body 35 between the inner periphery and the outer periphery of the wound electrode group 30. In the present embodiment, for example, “being curved” means “being curved in an arc shape at about 180° or more”.

For example, a preferable range within which the abutting portion 21 faces the flat portion 36 of the wound electrode group 30 can be defined as follows. First, as illustrated in FIG. 4B, in a cross section cut along a compression direction of the wound electrode group 30 when the wound electrode group 30 is pressed and compressed flatly between the pair of flat surfaces S1 and S2, that is, a thickness direction of the wound electrode group 30, as illustrated in FIG. 5B, a pair of virtual circles C1 and C1 passing through apexes of the curved portion 37 and 37 at both ends of the flat portion 36, for example, apexes P0 and P0 of the negative electrode 32 on the outermost periphery with centers in the thickness direction at both ends of the flat portion 36 as centers O1 and O1 is assumed. In FIG. 5B, only the virtual circle C1 at one end of the flat portion 36 is illustrated. Next, points P1 and P1 where the pair of virtual circles C1 and C1 intersects the outermost periphery of the flat portion 36, for example, an outer peripheral surface of the negative electrode 32 wound in the outermost periphery, are specified. The abutting portion 21 preferably faces the flat portion 36 within a range R1 between the two points P1 and P1, including the points P1 and P1, in the flat portion 36 of the wound electrode group 30.

For example, a more preferable range within which the abutting portion 21 faces the flat portion 36 of the wound electrode group 30 can be defined as follows. First, a pair of second virtual circles C2 having the same center O1 as the above pair of virtual circles C1 and C1 and a radius r2 is assumed. The radius r2 is an average between a radius r1 of the virtual circle C1 and a distance d1 from the center O1 to the outermost periphery of the flat portion 36, for example, to the outer peripheral surface of the negative electrode 32 wound in the outermost periphery. In FIG. 5B, only the second virtual circle C2 at one end of the flat portion 36 is illustrated. Next, points P2 and P2 where the pair of second virtual circles C2 and C2 intersects the outermost periphery of the flat portion 36, for example, the outer peripheral surface of the negative electrode 32 wound in the outermost periphery, are specified. The abutting portion 21 preferably faces the flat portion 36 within a range R2 between the two points P2 and P2, including the points P2 and P2, in the flat portion 36 of the wound electrode group 30.

On the other hand, the facing portions 22 and 22 are integrated with the abutting portion 21 at both ends of the abutting portion 21, and face the curved portions 37 and 37 at both ends of the flat portion 36. In the present embodiment, the facing portions 22 and 22 also face both ends of the flat portion 36 in the wound electrode group 30. For example, when the facing portions 22 and 22 are integrated with a battery holder for holding the secondary battery 10, the facing portions 22 and 22 may be disposed separately from the abutting portion 21. The thickness T2 of the facing portion 22 is smaller than the thickness T1 of the abutting portion 21, and the abutting portion 21 abuts on the wide surface 1a of the battery container 10. Therefore, when the battery container 1 is not expanded, the facing portion 22 faces the wide surface 1a with a space between the facing portion 22 and the wide surface 1a of the battery container 1. The thickness T2 of the facing portion 22 is set to the thickness T2 with which the facing portion 22 abuts on the wide surface 1a of the battery container 1 before the battery container 1 expands beyond an allowable range.

Next, a function of the assembled battery 100 of the present embodiment, having the above structure, will be described.

In the secondary battery 10 included in the assembled battery 100, the battery container 1 is expanded due to expansion of the wound electrode group 30 with charging and discharging. Here, in the assembled battery 100, a pair of metal plates (not illustrated) is disposed at both ends of the plurality of secondary batteries 10 laminated with the spacer 20 interposed therebetween, and these metal plates are fastened mutually with a bolt or the like to tighten the plurality of secondary batteries 10 laminated. This suppresses expansion of the battery container 1 of each secondary battery 10.

In a conventional assembled battery, a spacer abutting on the wide surface 1a of the secondary battery 10 has a flat surface abutting on the wide surface 1a of the secondary battery 10, and abuts on the wide surface 1a of the secondary battery 10 within a range facing the entire wound electrode group 30 including the flat portion 36 and the curved portion 37. In this case, as illustrated in FIG. 4B, the wound electrode group 30 expanded in the battery container 1 is in a similar state to the state in which the entire wound electrode group 30 is pressed between the pair of flat surfaces S1 and S1.

Then, as illustrated in FIG. 5B, a distance between the electrodes 31 and 32 is increased in the curved portion 37 due to the peripheral length difference between the electrodes 31 and 32 wound in the inner periphery and the outer periphery. Such a gap G between the electrodes 31 and 32 is larger as a distance to the apex P0 of the curved portion 37 is shorter. Therefore, for example, the large gap G is locally formed between the electrodes 31 and 32 at the apex P0 of the curved portion 37. That is, the distance between the electrodes 31 and 32 at the apex P0 of the curved portion 37 is longer than a distance between the electrodes 31 and 32 in the flat portion 36. Therefore, in the conventional assembled battery, in a portion having the large gap G between the electrodes 31 and 32, resistance between the positive and negative electrodes 31 and 32 may be increased, metal lithium may be deposited on the negative electrode 32, and charging and discharging performance of the wound electrode group 30 may be deteriorated.

On the other hand, as illustrated in FIG. 5A, in the assembled battery 100 of the present embodiment, the spacer 20 has the abutting portion 21 abutting on the wide surface 1a of the battery container 1 within the range R3 facing the inner side of the both ends of the flat portion 36 in the wound electrode group 30.

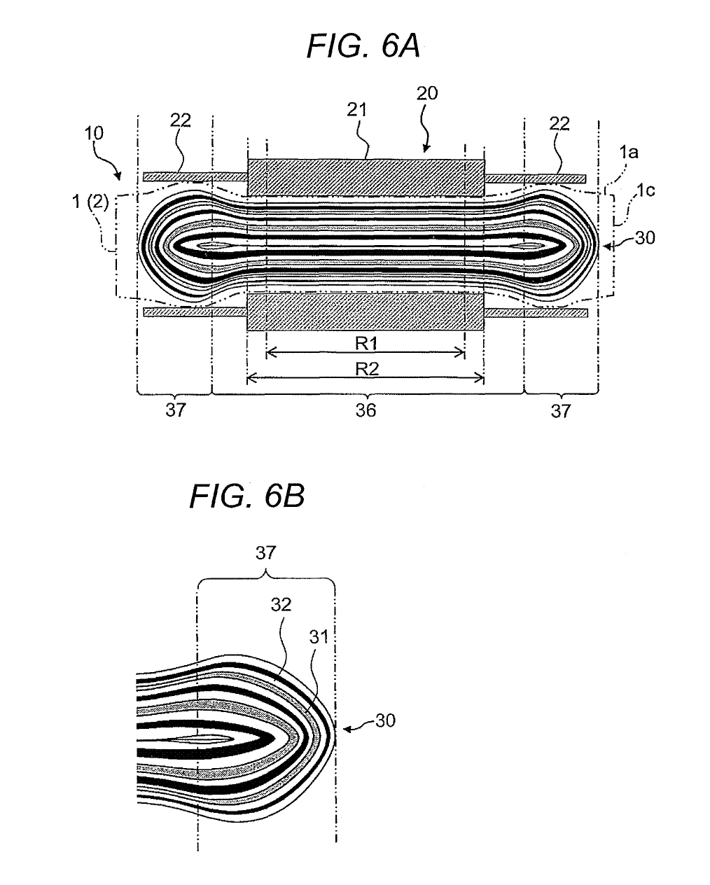

FIG. 6A is a cross sectional view illustrating the secondary battery 10 in which the battery container 1 is expanded due to expansion of the wound electrode group 30, corresponding to FIG. 5A. FIG. 6B is an enlarged cross sectional view illustrating the curved portion in the wound electrode group 30 illustrated in FIG. 6A. In FIGS. 6A and 6B, expansion is emphasized more than actual expansion for easy understanding. It is difficult to recognize the actual amount of deformation due to expansion of the wound electrode group 30 with the naked eye.

As illustrated in FIG. 6A, during expansion of the wound electrode group 30, the flat portion 36 abuts on the wide surface 1a of the battery container 1, and a force to stretch out the wide surface 1a from the inner side to the outer side acts. Here, as illustrated in FIG. 5A, the abutting portion 21 of the spacer 20 abuts on the wide surface 1a before expansion of the battery container 1 of the secondary battery 10, and is tightened while the abutting portion 21 faces the flat portion 36 of the wound electrode group 30. Therefore, the abutting portion 21 can apply a resistance force directed from the outer side to the inner side with respect to the wide surface 1a. Therefore, the abutting portion 21 can control expansion of the wide surface 1a due to expansion of the flat portion 36 and suppress expansion of the battery container 1. The abutting portion 21 does not abut on the wide surface 1a of the battery container 1 at a position facing the curved portion 37 of the wound electrode group 30, and therefore can allow expansion of the battery container 1 due to expansion of the curved portion 37. The curved portion 37 of the wound electrode group 30 is thereby enlarged in an arc shape in a thickness direction at both sides of the flat portion 21, and is expanded into a dumbbell shape.

In this way, the cross sectional shape of the curved portion 37 is closer to a circle by allowance of expansion of the curved portion 37. As illustrated in FIG. 6B, the distance between the electrodes 31 and 32 in the curved portion 37 is thereby made uniform, and the large gap G is not formed locally. Therefore, the assembled battery 100 of the present embodiment can make resistance between the electrodes 31 and 32 in the curved portion 37 uniform, prevent deposition of metal lithium onto the negative electrode 32, suppress deterioration of charging and discharging performance of the electrode, and suppress deterioration of charging and discharging performance of the secondary battery 10.

In the present embodiment, the flat portion 36 of the wound electrode group 30 is a portion where the entire laminated body 35 is flat from the innermost periphery to the outermost periphery when the wound electrode group 30 is compressed flatly between the pair of flat surfaces S1 and S2. Therefore, the abutting portion 21 abutting on the wide surface 1a of the battery container 1 within a range facing the inner side of the both ends of the flat portion 36 can allow deformation of the curved portion 37 in a thickness direction, make the shape of the curved portion 37 after expansion closer to a circle, and make the distance between the electrodes 31 and 32 in the curved portion 37 uniform. That is, when the abutting portion 21 abuts on the wide surface 1a of the battery container 1 at both ends of the flat portion 36 of the wound electrode group 30 or in the outer side of the both ends of the flat portion 36, that is, even within a range facing the curved portion 37, as illustrated in FIG. 4B, the wound electrode group 30 is in a similar state to the state in which the entire wound electrode group 30 is pressed between the pair of flat surfaces S1 and S1, deformation of the curved portion 37 in a thickness direction is prevented, and the distance between the electrodes 31 and 32 in the curved portion 37 cannot be made to be uniform sufficiently.

In the present embodiment, as illustrated in FIGS. 5A and 5B, the abutting portion 21 faces the flat portion 36 within the range R1 between the two points P1 and P1 where the pair of virtual circles C1 and C1 intersects the outermost periphery of the flat portion 36, including the points P1 and P1. This makes it possible to surely prevent expansion of the battery container 1 within the range facing the flat portion 36, to make the curved portion 37 expanded so as to have a cross sectional shape closer to a circle, and to make the distance between the electrodes 31 and 32 in the curved portion 37 more uniform.

Furthermore, in the present embodiment, the abutting portion 21 faces the flat portion 36 within the range R2 between the two points P2 and P2 where the pair of virtual circles C2 and C2 intersects the outermost periphery of the flat portion 36, including the points P2 and P2. Therefore, the abutting portion 21 makes it possible to more surely prevent expansion of the battery container 1 within the range facing the flat portion 36 by increasing the width in which the abutting portion 21 faces the flat portion 36 along the height direction of the battery container 1, that is, along a direction perpendicular to the bottom surface 1c, to make the curved portion 37 deformed in the thickness direction so as to have a cross sectional shape closer to a circle, and to make the distance between the electrodes 31 and 32 in the curved portion 37 more uniform.

In the present embodiment, the spacer 20 has the facing portion 22 facing the wide surface 1a of the battery container 1 within a range facing at least a part of the curved portion 37 of the wound electrode group 30. The thickness T2 of the facing portion 22 is smaller than the thickness T1 of the abutting portion 21. In this way, by making the thickness T2 of the facing portion 22 smaller than the thickness T1 of the abutting portion 21, a space for expansion of the battery container 1 is formed between the facing portion 22 and the wide surface 1a of the battery container 1 before expansion. This space can allow expansion of the battery container 1 due to expansion of the curved portion 37 and make the distance between the electrodes 31 and 32 in the curved portion 37 uniform. In addition, the facing portion 22 has the thickness T2 with which the facing portion 22 abuts on the wide surface 1a of the battery container 1 before the battery container 1 expands beyond an allowable range due to expansion of the curved portion 37. It is thereby possible to make the facing portion 22 apply a resistance force against expansion of the battery container 1 with respect to the wide surface 1a, to suppress expansion of the battery container 1 beyond an allowable range, and to prevent deterioration of performance of the secondary battery 10.

As described above, the assembled battery 100 of the present embodiment can suppress expansion of the battery container 1 of the secondary battery 10, suppress local deposition of metal lithium onto the electrode 32 in the wound electrode group 30, and suppress deterioration of charging and discharging performance of the secondary battery 10.

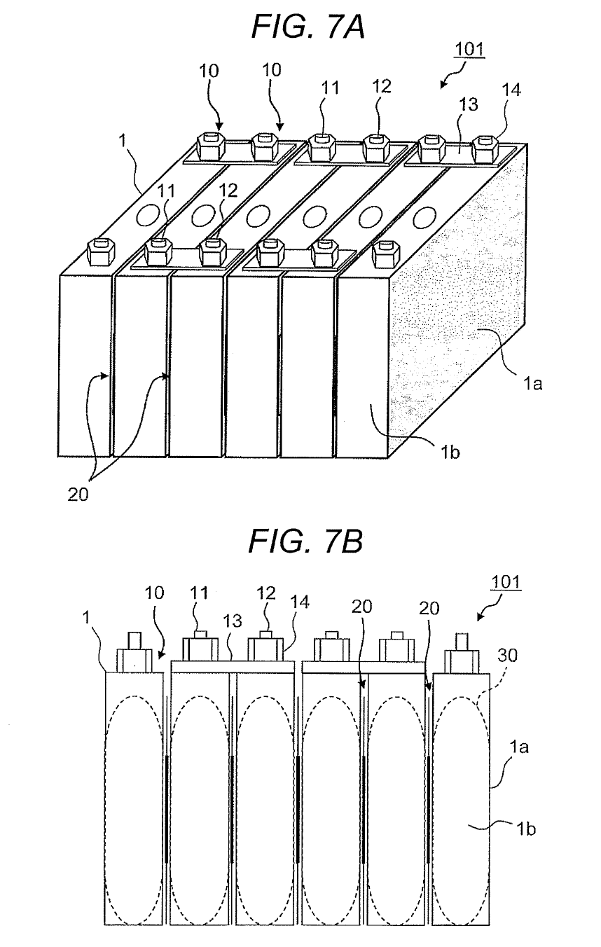

The spacer 20 may be a resin molded body manufactured, for example, by injection molding. When the thickness of the spacer 20 is relatively small, the spacer 20 having a film shape can be also used. An example thereof is illustrated in FIGS. 7A and 7B.

FIG. 7A is a perspective view illustrating an assembled battery 101 in a modified example of the assembled battery 100 in the above embodiment. FIG. 7B is a side view of the assembled battery 101 illustrated in FIG. 7A.

The assembled battery 101 in the present modified example is different from the assembled battery 100 of the above embodiment in that the spacer 20 is thin and is formed into a film shape. The assembled battery 101 is the same as the assembled battery 100 in the other points, and therefore description will be omitted. The present modified example can simplify a manufacturing process to reduce cost because the spacer 20 has a film shape. In addition, the present modified example can reduce a space for disposing the spacer 20 to downsize the assembled battery 101 advantageously.

### Second Embodiment

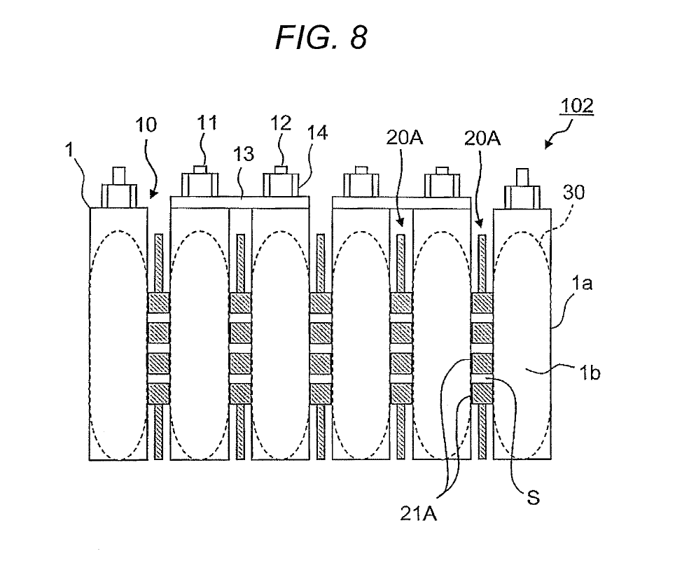

Next, an assembled battery according to a second embodiment of the present invention will be described with reference to FIG. 8 while FIGS. 1 to 6A and 6B are quoted. FIG. 8 is a side cross sectional view of an assembled battery 102 according to the present embodiment, corresponding to FIG. 1B in the first embodiment.

The assembled battery 102 of the present embodiment is different from the assembled battery 100 of the first embodiment in that the assembled battery 102 includes a battery holder (not illustrated) for housing a secondary battery 10, a spacer 20 is integrated with the battery holder, and an abutting portion 21A is divided into a plurality of parts to form a slit S through which a fluid passes along wide surfaces 1a and 1a of battery containers 1 and 1. The assembled battery 102 is the same as the assembled battery 100 of the first embodiment in the other points. Therefore, the same signs are given to the same parts, and description will be omitted.

The assembled battery 102 of the present embodiment can obtain a similar effect to the assembled battery 100 of the first embodiment, and in addition, can cool the battery container 1 of the secondary battery 10 by making a coolant pass through the slit S. Therefore, the assembled battery 102 can further improve performance of the secondary battery 10.

Hereinabove, preferable embodiments of the present invention have been described. However, the present invention is not limited to the above embodiments, but includes various modified examples. The above embodiments have been described in detail in order to explain the present invention to be understood easily. The present invention does not necessarily include all the components described above.

For example, the above embodiments have described a spacer having a facing portion. However, when expansion of a battery container due to expansion of a curved portion of a wound electrode group is within an allowable use range of an assembled battery, the facing portion can be omitted.

### REFERENCE SIGNS LIST

1 battery container
1a wide surface
20, 20A spacer
21 abutting portion
21A abutting portion
22 facing portion
30 wound electrode group
31 positive electrode
32 negative electrode
33, 34 separator
35 laminated body
36 flat portion
37 curved portion
100, 101, 102 assembled battery
C1 virtual circle
C2 second virtual circle
d1 distance from center of virtual circle to outermost periphery of flat portion
O1 center
P0 apex of curved portion
P1 point at which virtual circle intersects outermost periphery of flat portion
P2 point at which second virtual circle intersects outermost periphery of flat portion
R1 range between two points where a pair of virtual circles intersects outermost periphery of flat portion, including the points
R2 range between two points where a pair of second virtual circles intersects outermost periphery of flat portion, including the points
R3 range facing inner side of both ends of flat portion
R4 range facing curved portion
r1 radius of virtual circle
r2 radius of second virtual circle
S slit
S1, S2 flat surface
T1 thickness of abutting portion
T2 thickness of facing portion

1. An assembled battery formed by laminating secondary batteries each including a flat wound electrode group formed by winding a laminated body including positive and negative electrodes laminated with a separator interposed therebetween and a flat battery container for housing the wound electrode group with a spacer interposed therebetween, wherein
the wound electrode group has a flat portion where the laminated body is formed by flat lamination and a curved portion where the laminated body is formed by curved lamination at least in a part at both ends of the flat portion,
the spacer has an abutting portion that abuts on a wide surface of the battery container within a range facing the inner side of the both ends of the flat portion and a facing portion that faces the wide surface of the battery container within a range facing the curved portion, and
the thickness of the facing portion is smaller than the thickness of the abutting portion.

2. The assembled battery according to claim 1, wherein the flat portion is a portion where the entire laminated body is flat from the innermost periphery to the outermost periphery when the wound electrode group is compressed flatly between a pair of flat surfaces.

3. The assembled battery according to claim 2, wherein
when, in a cross section cut along a compression direction of the wound electrode group compressed flatly between the pair of flat surfaces, a pair of virtual circles passing through apexes of the curved portion at both sides of the flat portion with centers in the thickness direction at both ends of the flat portion as centers is assumed,
the abutting portion faces the flat portion within a range between two points where the pair of virtual circles intersects the outermost periphery of the flat portion, including the points.

4. The assembled battery according to claim 3, wherein
when a pair of second virtual circles having the same center as the pair of virtual circles and a radius that is an average between the radius of the virtual circle and a distance from the center to the negative electrode on the outermost periphery of the flat portion is assumed,
the abutting portion faces the flat portion within a range between two points where the pair of second virtual circles intersects the outermost periphery of the flat portion, including the points.

5. The assembled battery according to claim 1, wherein the abutting portion of the spacer is divided into a plurality of parts to form a slit through which a fluid passes along a wide surface of the battery container.
